(19) United States
(12) Patent Application Publication
(10) Pub. No.: US 2003/0195295 A1
(43) Pub. Date: Oct. 16, 2003

(54) Miscible blends of polyesters and polycarbonates with good thermal characteristics, and related processes and articles

(75) Inventors: James Alan Mahood, Evansville, IN (US); Zhaohui Su, Evansville, IN (US); Paul Honigfort, Evansville, IN (US)

Correspondence Address: Frank A. Smith, GE Plastics, One Plastics Avenue, Pittsfield, MA, 01201, US

(73) Assignee: General Electric Company

(21) Appl. No.: 10/123,146

(22) Filed: Apr. 16, 2002

(51) Int. Cl. C08L 51/00

(52) U.S. Cl. 525/67

(57) ABSTRACT

Thermoplastic compositions are described, containing a cycloaliphatic polyester resin, along with selected polycarbonates or copolycarbonates. The polycarbonates are usually based on dihydroxydiphenyl cyclohexanes, or on bisphenols prepared from cyclic monoterpene precursors. The compositions may be transparent or translucent. Moreover, they may include a rubbery impact modifier. Related processes and articles are also described.

### TECHNICAL FIELD

The present invention generally relates to thermoplastic molding materials. More specifically, the invention is directed to improvements in thermoplastic blends based on polyester and polycarbonate resins.

### BACKGROUND OF THE INVENTION

Polycarbonates are highly-regarded resins which generally possess many desirable characteristics. For example, they usually have excellent impact strength and dimensional stability. Polycarbonates also possess high creep resistance, low water absorption, and good electrical properties, e.g., as a structural support material for current-carrying parts. General purpose polycarbonate resins can also be formulated to be highly transparent or translucent, depending on the requirements for a particular application.

In several areas, polycarbonates can be somewhat deficient. For example, they typically have high melt viscosities, which can make them difficult to mold. Such a deficiency can often be minimized by blending the polymer with a polyester resin, which can lower the melt viscosity of the composition, for better “flow”. Miscible blends of polycarbonates with certain polyesters are described in U.S. Pat. Nos. 3,218,372; 4,125,572; 4,188,314; and U.K. Patent Specification 1,559,230.

Polycarbonates and polycarbonate-polyester blends are sometimes deficient in low-temperature impact resistance (ductility), e.g., at temperatures in the range of about −20° C. to −60° C. The impact resistance of these formulations is usually improved by the addition of an impact modifier. Rubbery materials are widely available for this purpose.

The miscibility of polymers in a blend is often very important for properties like transparency. As described in U.S. Pat. No. 4,125,572, some blends of polycarbonate and poly(1,4-butylene terephthalate) (PBT) tend to lose their transparency when the level of PBT is greater than about 10%. The transparency loss is the result of the polymers becoming at least partly immiscible with one another, forming separate phases. The presence of materials like rubbery impact modifiers may also result in immiscibility and, consequently, loss of transparency.

The opaqueness of an immiscible blend is caused by the difference (even a small difference) in refractive index (RI) values between constituents in the polymer blend. As an example, polycarbonate has a relatively high RI of about 1.58, whereas a rubbery component may have an RI value in the range of about 1.48-1.56. As alluded to earlier, the loss of transparency will make the polymer blend unsuitable for many important end use applications, such as glazing and various packaging products.

An inventive response to the problems associated with immiscible polymer blends is described in a patent application assigned to the assignee of the present invention, Ser. No. 09/736,879 (Docket 8CV-5977), filed on Dec. 14, 2000. (Ser. No. 09/736,879 is based on provisional application Ser. No. 60/246,395, filed on Nov. 7, 2000). In that patent application, a transparent molding composition is described. The composition is based on a miscible resin blend of a polycarbonate resin and a cycloaliphatic polyester resin.

The polycarbonates described in Ser. No. 09/736,879 are generally based on dihydric phenols such as 2,2-bis(4-hydroxyphenyl)propane (bisphenol-A). They can also be based on compounds which provide low birefringence, such as spirobiindane-derived phenols. The preferred cycloaliphatic polyesters in Ser. No. 09/736,879 appear to be based on cyclohexane dimethanol and cyclohexanedicarboxylate-type compounds. Moreover, the blends contain an impact-modifying amorphous resin, which improves low-temperature ductility. The polycarbonate/cycloaliphatic polyester phase of these compositions has an RI value which substantially matches the RI value of the impact modifier.

The molding compositions of Ser. No. 09/736,879 are characterized by a combination of desirable characteristics. For example, the compositions have improved flow, as compared to polycarbonate resin itself. Moreover, the molded products are very ductile and impact-resistant—even at temperatures lower than 0° C. Furthermore, the compositions can be molded into articles which have high transparency—even when significant amounts of rubbery materials are present. Transparency can be conveniently maintained when using rubbery materials of different RI values by varying the level and ratio of polycarbonate and polyester in the overall blend.

While the compositions of Ser. No. 09/736,879 are extremely useful for many applications, they do have some drawbacks. In general, the addition of aliphatic polyesters to polycarbonate compositions generally lowers the glass transition temperature (Tg) of the overall composition. A decrease in Tg will disqualify the polymer composition from being used in a variety of high-heat applications.

The problem of low Tg is especially severe when the composition contains significant amounts of the rubbery impact modifier. Certainly, the addition of the aliphatic polyester to the composition can effectively reduce the RI of the polyester-polycarbonate phase, so that it matches the RI of the impact modifier. However, the large amount of polyester which is often needed to accomplish this goal dramatically reduces the Tg of the composition.

The following example demonstrates the problem. It is based on the use of a typical bisphenol A (BPA)-type polycarbonate; a cycloaliphatic polyester (e.g., a “PCCD” material, as discussed below); and an exemplary rubber-based impact modifier having a RI of 1.54. The BPA polycarbonate has a RI of about 1.58, and a Tg of about 150° C., while the polyester has a RI of about 1.53, and a Tg of about 70° C. A 20/80 blend (by weight) of BPA polycarbonate/polyester would be required to match the RI of the impact modifier. However, the resulting composition (with such a high proportion of polyester) would have a Tg of only about 85° C. Such a material would be unacceptable for many applications in which heat resistance is required.

It should be apparent from this discussion that improved blends of polycarbonates and polyester resins would be welcome in the art. The blends should be characterized by a high degree of miscibility over a wide range of resin proportions. Moreover, the blends should also be capable of accommodating the optional presence of an impact modifier, which enhances ductility and impact resistance. Furthermore, it would be highly beneficial if the composition of these impact-modified blends could be adjusted for maximum transparency, when such a property is desired. In addition, the transparent, impact-modified blends should preferably have thermal properties (like Tg) which surpass those of similar blends of the prior art.

### SUMMARY OF THE INVENTION

A primary embodiment of this invention is directed to a thermoplastic composition, comprising:

a) from about 1 part by weight to about 99 parts by weight of a cycloaliphatic polyester resin; and

b) from about 99 parts by weight to about 1 part by weight of a polycarbonate or copolycarbonate comprising

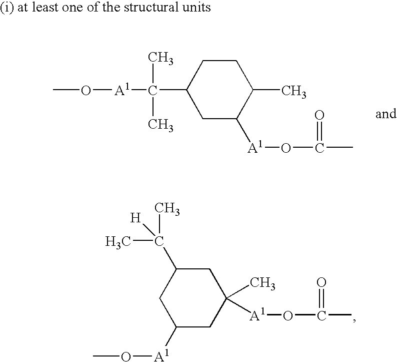

,wherein each A¹ is independently a divalent substituted or unsubstituted aromatic group;

or

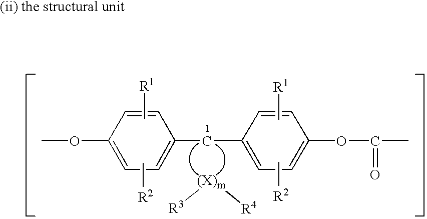

,wherein each R¹ and R² is independently hydrogen, halogen, C₁-C₈ alkyl, C₅-C₆ cycloalkyl, C₅-C₁₀ aryl, and C₇-C₁₂ aralkyl;

m is an integer of from about 4 to about 7;

R³ and R⁴ are individually selectable for each X, and independently represent hydrogen or C₁-C₆ alkyl; and

X represents carbon, with the proviso that, for at least one atom X, both R³ and R⁴ are alkyl.

The ratio of cycloaliphatic polyester resin to polycarbonate or copolycarbonate resin is usually in the range of about 80:20 to about 5:95, by weight. The cycloaliphatic polyester resin is often a material like poly(1,4-cyclohexane-dimethanol-1,4-dicarboxylate) (PCCD). In some embodiments, the homopolycarbonates are those derived from bisphenols like 4-[1-[3-(4-hydroxyphenyl)-4-methylcyclohexyl]-1-methylethyl]-phenol or 4,4′-[1-methyl-4-(1-methylethyl)-1,3-cyclohexandiyl]bisphenol. In other embodiments, the homopolycarbonates are derived from various dihydroxydiphenyl cyclohexanes described below. The copolycarbonates include the dihydroxy-derived units mentioned above, along with additional carbonate structural units, e.g., those based on bisphenol A.

In some embodiments, the compositions further include an impact modifier. These materials are further described below; they are often substantially transparent. In many embodiments, the refractive index of the impact modifier is matched by selecting proportions of the aliphatic polyester and polycarbonate or copolycarbonate components. As further described below, the compositions of this invention allow for unique enhancement in a combination of desirable characteristics, such as transparency, good thermal properties, and good impact properties.

Another embodiment of the invention is directed to a process for molding thermoplastic articles. The first step usually involves the formation of a resin blend of cycloaliphatic polyester and polycarbonate (or copolycarbonate) materials described herein. An impact modifier having a predetermined index of refraction is also usually included in the blend. In that instance, the relative proportions of the polyester and the polycarbonate are selected to match the index of refraction of the impact modifier. In a following step, an article is molded from the resin blend, using conventional techniques. The compositions described herein provide the flexibility for good molding conditions, while maximizing the other desired properties.

Articles prepared by the processes described herein constitute still another embodiment of this invention. The articles are often in the form of an extruded sheet, which can be transparent or translucent. The sheet product is also characterized by very desirable thermal and impact properties.

Further details regarding the various features of this invention are found in the remainder of the specification.

### BRIEF DESCRIPTION OF THE DRAWINGS

FIG. 1 is a graph depicting glass transition temperature as a function of component-concentration for compositions of the present invention.

FIG. 2 is another graph depicting glass transition temperature as a function of component-concentration for compositions of the present invention.

FIG. 3 is a third graph, depicting glass transition temperature as a function of component-concentration for compositions of the present invention.

### DETAILED DESCRIPTION OF THE INVENTION

Component (a) of the present invention is a cycloaliphatic polyester. Such a material is generally known in the art. References for similar polyesters include U.S. Pat. No. 5,859,119; UK Patent Specification 1,559,230; and the above-mentioned patent application Ser. No. 09/736,879, all of which are incorporated herein by reference. The cycloaliphatic polyesters are usually condensation products of aliphatic diacids, or chemical equivalents, and aliphatic diols, or their chemical equivalents. They may be formed from mixtures of aliphatic diacids and aliphatic diols. However, they usually must contain at least about 50 mole % of cyclic diacid and/or diol components, the remainder, if any, being linear aliphatic diacids and/or diols. The cyclic components are useful for imparting good rigidity, and they do not absorb UV light under normal exposure conditions. Thus, the resulting molded articles have excellent weatherability properties. As described in Ser. No. 09/736,879, cycloaliphatic polyesters having only one cyclic unit may sometimes be employed.

In many preferred embodiments, the cycloaliphatic polyesters are condensation products of cycloaliphatic diols and cycloaliphatic diacids, or chemical equivalents of the diacids. Examples include the salts, esters or acid halides of the diacids—preferably, the 1,4-cyclohexyl diacids, and most preferably, greater than about 70 mole % thereof in the form of the trans isomer. The preferred cycloaliphatic diols are 1,4-cyclohexyl primary diols such as 1,4-cyclohexyl dimethanol. Most preferably, more than about 70 mole % of the diols are in the form of the trans isomer.

The diols useful in the preparation of the polyester resins of the present invention are straight chain, branched, or preferably cycloaliphatic alkane diols, and may contain from about 2 to about 12 carbon atoms. Non-limiting examples of such diols are as follows: ethylene glycol; propylene glycol, i.e., 1,2- and 1,3-propylene glycol; butanediol, i.e., 1,3- and 1,4-butanediol; diethylene glycol; 2,2-dimethyl-1,3-propanediol; 2-ethyl-2-methyl-1,3-propanediol; 1,3- and 1,5-pentanediol; dipropylene glycol; 2-methyl-1,5-pentanediol; 1,6-hexanediol; dimethanol decalin, dimethanol bicyclo octane; 1,4-cyclohexanedimethanol, and particularly its cis- and trans-isomers; triethylene glycol; 1,10-decanediol; and mixtures of any of the foregoing.

Preferably, a cycloaliphatic diol or chemical equivalent thereof is used as the diol component. As mentioned above, 1,4-cyclohexane dimethanol or its chemical equivalents is particularly suitable as the diol component, e.g., a mixture of cis- and trans-isomers thereof. Chemical equivalents of the diols include esters, such as dialkylesters, diaryl esters and the like.

The diacids useful in the preparation of the aliphatic polyester resins of the present invention are preferably cycloaliphatic diacids, e.g., those containing about 6 to about 12 carbon atoms. Such a term is meant to include carboxylic acids having two carboxyl groups, each of which is attached to a saturated carbon. Preferred diacids are cyclo or bicyclo aliphatic acids, for example, decahydro naphthalene dicarboxylic acids, norbornene dicarboxylic acids, bicyclo octane dicarboxylic acids; and 1,4-cyclohexanedicarboxylic acid, or chemical equivalents thereof. An especially preferred diacid is trans-1,4-cyclohexanedicarboxylic acid, or its chemical equivalent.

Methods for preparing cyclohexanedicarboxylic acids and their chemical equivalents are known in the art. They can be prepared, for example, by the hydrogenation of cycloaromatic diacids and corresponding derivatives, such as isophthalic acid, terephthalic acid or naphthalenic acid, in a suitable solvent (e.g., water or acetic acid), at room temperature, and at atmospheric pressure. An exemplary catalyst for these reactions is rhodium, supported on a suitable carrier of carbon or alumina. See, Friefelder et al, Journal of Organic Chemistry, 31, 3438 (1966); as well as U.S. Pat. Nos. 2,675,390 and 4,754,064. The cyclohexanedicarboxylic acids may also be prepared by the use of an inert liquid medium in which a phthalic acid is at least partially soluble under reaction conditions, using a catalyst of palladium or ruthenium in carbon or silica. (See, for example, U.S. Pat. Nos. 2,888,484 and 3,444,237).

Typically, in the hydrogenation reaction, two isomers are obtained, in which the carboxylic acid groups are in cis- or trans-positions. The cis- and trans-isomers can be separated by crystallization, with or without a solvent, such as n-heptane, or by distillation. The cis-isomer tends to blend better. However, the trans-isomer has higher melting and crystallization temperatures, and is especially preferred. Mixtures of the cis- and trans-isomers are useful herein as well. When such a mixture is used, the trans-isomer will preferably comprise at least about 70 parts by weight. When the mixture of isomers is used, or when more than one diacid is used, a copolyester, or a mixture of two polyesters may be employed as the presently-described cycloaliphatic resin.

Chemical equivalents of these diacids include esters, alkyl esters, e.g., dialkyl esters, diaryl esters, anhydrides, salts, acid chlorides, acid bromides, and the like. The preferred chemical equivalents comprise the dialkyl esters of the cycloaliphatic diacids. For many embodiments, the most preferred chemical equivalent comprises the dimethyl ester of the acid, particularly dimethyl-trans-1,4-cyclohexane-dicarboxylate.

The polyester resins of the present invention are typically obtained through the condensation or ester interchange polymerization of the diol or diol-equivalent component with the diacid or diacid-chemical equivalent component. The resins usually comprise repeating units of the formula

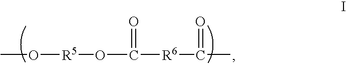

wherein R⁵ represents an alkyl, aryl, or cycloalkyl radical containing about 2 to about 20 carbon atoms. The radical is the residue of a straight chain, branched, or cycloaliphatic alkane diol having about 2 to about 12 carbon atoms or chemical equivalents thereof R⁶ is an alkyl or a cycloaliphatic radical which is the decarboxylated residue derived from a diacid, or chemical equivalent thereof. At least one of R⁵ and R⁶ is a cycloalkyl group.

A preferred cycloaliphatic polyester in many instances is poly(1,4-cyclohexane-dimethanol-1,4-dicarboxylate) (PCCD), which has recurring units of the formula

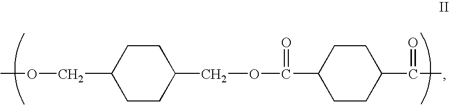

With reference to the previously set-forth general formula for the polyester resins, for PCCD: R⁵ is derived from 1,4-cyclohexane dimethanol; and R⁶ is a cyclohexane ring derived from cyclohexanedicarboxylate or a chemical equivalent thereof. In many preferred embodiments, PCCD has a cis/trans formula.

The polyester polymerization reaction is generally run in the presence of a suitable catalyst, such as a tetrakis (2-ethyl hexyl) titanate. Those skilled in the art can select the most appropriate level of catalyst. It is typically about 50 ppm to about 200 ppm of titanium, based upon the final product. The preferred aliphatic polyesters used in the present molding compositions have a glass transition temperature (Tg) which is above about 50° C., and more preferably, about 70° C. or greater.

In some embodiments of this invention, the polyesters described above can further include, from about 1% to about 50% by weight, of units derived from polymeric aliphatic acids and/or polymeric aliphatic polyols, so as to form copolyesters. The aliphatic polyols include glycols, such as poly(ethylene glycol) or poly(butylene glycol). Such polyesters can be made following the teachings of, for example, U.S. Pat. Nos. 2,465,319 and 3,047,539.

Component (b) of the present invention is a polycarbonate or copolycarbonate which comprises one or more of several different structural units. (For simplicity, these materials are sometimes referred to herein as only the “polycarbonates”, it being understood that the term is meant to include “copolycarbonates” as well). The class (i) polycarbonates comprise at least one of the structural units

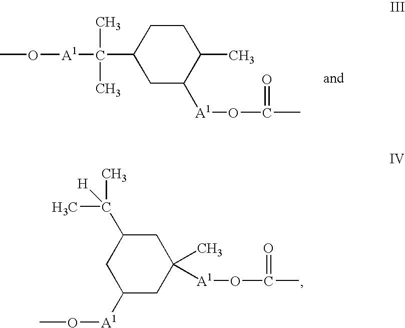

wherein each A¹ is independently a divalent substituted or unsubstituted aromatic group. These materials are based on bisphenols which are usually prepared from cyclic monoterpenes. The bisphenols, and polycarbonates prepared therefrom, are described, for example, in U.S. Pat. No. 5,480,959, which is incorporated herein by reference.

Some of the preferred bisphenols for preparing these polycarbonates are set forth as structures I and II in U.S. Pat. No. 5,480,959 (column 2), wherein each A¹ is as described above. Especially preferred bisphenols corresponding (respectively) to structures I and II are 4-[1-[3-(4-hydroxyphenyl)-4-methylcyclohexyl]-1-methylethyl]-phenol (sometimes referred to herein as “BPT-1”); and 4,4′-[1-methyl-4-(1-methylethyl)-1,3-cyclohexandiyl]bisphenol (sometimes referred to herein as “BPT-2”). (The structures for BPT-1 and BPT-2 are also set forth in the referenced patent). Moreover, U.S. Pat. No. 5,480,959 describes a technique for isolating the bisphenols. For example, substantially pure BPT-1 and BPT-2 can be isolated from a crude mixture which resulted from the reaction of phenols with a variety of cyclic monoterpenes.

Thus, homopolycarbonates for the present invention can be prepared using bisphenols BPT-1 or BPT-2. Those skilled in the art are familiar with various preparation techniques. For example, the bisphenols can be reacted with a carbonate source such as phosgene or diphenyl carbonate, using conventional techniques. These include melt polymerization, interfacial polymerization, and bischloroformate-based techniques (e.g., interfacial conversion to bischloroformates, followed by polymerization). Chain termination agents such as phenol may also be employed.

As mentioned above, copolycarbonates are sometimes preferred for the present invention. They usually include, in addition to the class (i) structural units described previously, at least one of the structural units of the formula

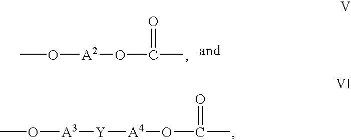

wherein A² is a divalent substituted or unsubstituted aliphatic, alicyclic or aromatic radical. A³ and A⁴ are each independently a monocyclic divalent aromatic radical, and Y is a bridging radical. In regard to Y, usually 1 to 4 atoms separate A³ from A⁴. The free valence bonds in formula V are usually in the meta or para positions of A³ and A⁴, in relation to Y. (Formula VI is a preferred species of formula V).

The A³ and A⁴ values may be unsubstituted phenylene, or substituted derivatives thereof Illustrative substituents (one or more) are alkyl, alkenyl, halo (especially chloro and/or bromo), nitro, alkoxy, and the like. Unsubstituted phenylene radicals are preferred. Both A³ and A⁴ are preferably p-phenylene, although both may be o- or m-phenylene, or one o- or m-phenylene and the other p-phenylene.

The bridging radical, Y, is one in which 1-4 atoms, preferably 1, separate A³ from A⁴. It is most often a hydrocarbon radical, and particularly, a saturated radical such as methylene, cyclohexylmethylene, 2-[2.2.1]-bicycloheptylmethylene, ethylene, isopropylidene, neopentylidene, cyclohexylidene, cyclopentadecylidene, cyclododecylidene or adamantylidene, especially a gem-alkylene (alkylidene) radical. Also included, however, are unsaturated radicals and radicals which contain atoms other than carbon and hydrogen. Examples are 2,2-dichloroethylidene, carbonyl, phthalidylidene, oxy, thio, sulfoxy and sulfone. For reasons of availability and particular suitability for the purposes of this invention, the preferred units of formula VI are 2,2-bis(4-phenylene)propane carbonate units, which are derived from bisphenol A. In that instance, Y is isopropylidene, and A² and A³ are each p-phenylene. Conventional techniques for preparing the copolycarbonates may be employed, as illustrated in the examples in U.S. Pat. No. 5,480,959.

The copolycarbonates used in this invention (both for class (i), now under discussion, and class (ii), discussed below) may include additional dihydroxy structural units. Many of them are set forth in U.S. Pat. No. 5,480,959 (e.g., formula VII in column 3). Non-limiting examples include:

2,2-bis(4-hydroxyphenyl)-propane (bisphenol A);

2,2-bis(3,5-dibromo-4-hydroxyphenyl)propane;

2,2-bis(3,5-dimethyl-4-hydroxyphenyl)propane;

1,1-bis(4-hydroxyphenyl)cyclohexane;

1,1-bis(3,5-dimethyl-4-hydroxyphenyl)cyclohexane;

1,1-bis(4-hydroxyphenyl)decane;

1,4-bis(4-hydroxyphenyl)propane;

1,1-bis(4-hydroxyphenyl)cyclododecane;

1,1-bis(3,5-dimethyl-4-hydroxyphenyl)cyclododecane;

4,4-dihydroxydiphenyl ether;

4,4-thiodiphenol;

4,4-dihydroxy-3,3-dichlorodiphenyl ether; and

4,4-dihydroxy-3,3-dihydroxydiphenyl ether.

Other dihydroxyaromatic compounds which are also suitable for use in the preparation of the copolycarbonates are disclosed in U.S. Pat. Nos. 2,999,835; 3,028,365; 3,334,154, 4,131,575, and 4,217,438, all of which are incorporated herein by reference. The preferred bisphenol is bisphenol A.

In some preferred embodiments of this invention, the copolycarbonate is a material based on a combination of bisphenol A and 4,4′-[1-methyl-4-(1-methylethyl)-1,3-cyclohexandiyl]bisphenol (“BPT-2”, and sometimes also referred to herein as “1,3-BHPM”). The weight ratio of bisphenol A to BPT-2 (or to other materials of this type, e.g., BPT-1) preferably ranges from about 1:99 to about 99:1. In preferred embodiments, the weight ratio ranges from about 30:70 to about 70:30.

As mentioned above, component (b) of this invention may comprise the class (ii) polycarbonates or copolycarbonates, i.e., those based on the structural unit

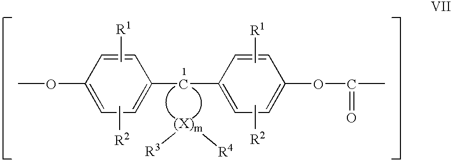

In this formula, each R¹ and R² is independently hydrogen, halogen, C₁-C₈ alkyl, C₅-C₆ cycloalkyl, C₅-C₁₀ aryl (preferably phenyl), and C₇-C₁₂ aralkyl; while m is an integer from about 4 to about 7. The R³ and R⁴ groups are individually selectable for each X, and independently represent hydrogen or C₁-C₆ alkyl. “X” represents carbon, with the proviso that, for at least one atom X, both R³ and R⁴ are alkyl. These polycarbonate materials are described in U.S. Pat. No. 5,126,428, which is incorporated herein by reference.

As described in U.S. Pat. No. 5,126,428, the polycarbonates are prepared from certain dihydroxydiphenyl cycloalkanes (formula I in that patent). These cycloalkanes can themselves be obtained by first reacting certain phenols with selected ketones (formulae V and VI, respectively, in the '428 patent). The phenols and the ketones are known in the art, or can be prepared by known methods. Preferred phenols and ketones are set forth in the '428 patent (e.g., the diphenols corresponding to formulae II, III, and IV therein). Moreover, the referenced patent describes the preparation of bisphenols from the phenols and ketones. Standard techniques may be used to prepare the polycarbonates from the bisphenols. For example, an interfacial process may be employed, using phosgene. Alternatively, a melt transesterification process may be carried out, using diphenyl carbonate.

In preferred embodiments, for structural unit V, each R³ and R⁴ for at least one atom “X” is, independently, an alkyl group. Usually, the alkyl group is a methyl group. Moreover, in some preferred embodiments, one X-atom in the beta position to C-1 is dialkyl-substituted, and one X-atom in the beta′ position to C-1 is monoalkyl-substituted.

Very often, the diphenyl-substituted C atom (C-1) and the X atoms in formula V form cycloaliphatic radicals containing five or six carbon atoms. In some preferred embodiments, structural unit (ii) comprises units corresponding to the formula

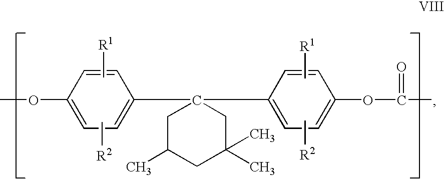

wherein R¹ and R² are as defined above. In preferred embodiments for this formula, R¹ and R² are hydrogen.

As in the case of the class (i) materials, copolycarbonates are sometimes preferred in this instance. In other words, these materials would include, in addition to the class (ii) structural units, at least one of the structural units of formulae V and VI, as described previously. A commercially-available example of such a copolymer material is APEC® 9353 polycarbonate copolymer, available from Bayer. Moreover, the class (ii) materials can include additional dihydroxy (e.g., dihydroxyaromatic) structural units as described above, such as bisphenol A.

Thus, another copolycarbonate preferred for some embodiments of this invention is a material based on a combination of bisphenol A and a dihydroxydiphenyl cycloalkane corresponding to the formula

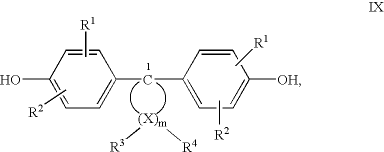

wherein R¹, R², R³, R⁴, X, and m are as defined previously. For these materials, the weight ratio of bisphenol A to dihydroxy compound IX ranges from about 1:99 to about 99:1. In preferred embodiments, the weight ratio ranges from about 30:70 to about 70:30.

For a preferred copolycarbonate of this type, the X atoms in the alpha position to the diphenyl-substituted C atom (C-1) are not dialkyl-substituted, while the X atoms in the beta position to C-1 are alkyl- or dialkyl-substituted. (See U.S. Pat. No. 5,126,428, for example). In some especially preferred embodiments, the dihydroxy compound IX is 1,1-bis-(4-hydroxyphenyl)-3,3,5-trimethyl cyclohexane), i.e., formula II of the referenced patent.

The polycarbonates or copolycarbonates of the present invention usually have a molecular weight (weight average) in the range of about 10,000 to about 60,000, as measured by gel permeation chromatography (polycarbonate standard). In some preferred embodiments, the molecular weight will be in the range of about 20,000 to about 40,000. Moreover, it is contemplated that the polycarbonates or copolycarbonates may have various known end groups.

As should be apparent from the teachings herein, the relative amounts of cycloaliphatic polyester and polycarbonate will depend in large part on the properties desired for the composition. In general, each component can be present at a level of about 1 part by weight to about 99 parts by weight. In some preferred embodiments, the ratio of cycloaliphatic polyester to polycarbonate will range from about 80:20 to about 5:95, by weight. In some especially preferred embodiments, the ratio will range from about 70:30 to about 30:70.

The presence of an impact modifier (discussed in detail below) will also factor greatly in selection of the relative amounts of polyester and polycarbonate. Typically, about 55% or less cycloaliphatic polyester (based on the sum of polyester and polycarbonate) is sufficient for matching the RI of conventional impact modifiers. In preferred embodiments, the level of cycloaliphatic polyester is less than about 40%. Again, other factors, such as required Tg specifications, will also influence selection of an appropriate amount of cycloaliphatic polyester.

As mentioned above, some embodiments of this invention include at least one impact modifier. Such materials are usually (but not always) substantially amorphous resins, and are very well-known in the art. Non-limiting examples are described in U.S. Pat. Nos. 5,859,119; 5,126,428; and patent application Ser. No. 09/736,879, all referenced above. The impact modifier often comprises one of several different rubbery modifiers, such as graft or core-shell rubbers, or combinations of two or more of these modifiers. Examples include the groups of modifiers known as acrylic rubbers, ASA rubbers, diene rubbers, organosiloxane rubbers, silicone rubbers, EPDM rubbers, SBS or SEBS rubbers, ABS rubbers, MBS rubbers, and glycidyl ester-based materials.

The term “acrylic rubber modifier” can refer to multi-stage, core-shell, interpolymer modifiers having a cross-linked or partially cross-linked (meth)acrylate rubbery core phase, preferably butyl acrylate. Associated with this cross-linked acrylic ester core is an outer shell of an acrylic or styrenic resin, preferably methyl methacrylate or styrene, which interpenetrates the rubbery core phase. Incorporation of small amounts of other monomers such as acrylonitrile or (meth)acrylonitrile within the resin shell also provides suitable impact modifiers. The interpenetrating network is formed when the monomers which constitute the resin phase are polymerized and cross-linked in the presence of the previously-polymerized and cross-linked (meth)acrylate rubbery phase.

For some embodiments of this invention, the preferred rubbers are graft or core-shell structures, with a rubbery component having a Tg below about 0° C., and preferably between about −40° C. and about −80° C. These materials comprise poly(alkylacrylates) or polyolefins grafted with PMMA (polymethyl methacrylate) or SAN (styrene-acrylonitrile). Preferably, the rubber content is at least about 40 wt %, and most preferably between about 60 and about 90 wt %. Especially suitable rubbers are the butadiene core-shell polymers of the type available from Rohm & Haas, for example, Paraloid® EXL2600.

In some especially preferred embodiments, the impact modifier will comprise a two-stage polymer having a butadiene-based rubbery core, and a second stage polymerized from methylmethacrylate, alone or in combination with styrene. Other suitable rubbers are the ABS types Blendex® 336 and 415, available from GE Specialty Chemicals. Both rubbers are based on the impact modifier resin of SBR rubber.

Although these mentioned impact modifiers appear to be very suitable, there are many more modifiers which can be used, and are known to those skilled in the polymer arts. In general, selection of a particular impact modifier will depend on a variety of factors. They include: cost, availability, room temperature- and low-temperature impact properties; refractive index; compatibility with the polycarbonate and polyester polymers; as well as overall optical and physical properties desired for the polymer system. In terms of refractive index (an important factor for some embodiments), an impact modifier with an RI between about 1.51 and about 1.58 can be used for this invention, as long as it possesses reasonable clarity.

The amount of impact modifier employed will of course depend on many of these same factors. The required amount of impact resistance is usually the primary factor. In some cases (but not all), the impact modifier will be present in the composition at a level between about 1% and about 30% by weight, based on the weight of the entire composition.

Compositions of the present invention may include one or more of a wide variety of additives. All of them are known in the art, as is their general level of effectiveness. Non-limiting examples include antioxidants, nucleating agents, minerals such as talc, clay, mica, barite, and wollastonite; stabilizers such as (but not limited to) thermal- and UV stabilizers; reinforcing fillers such as flaked or milled glass; flame retardants, pigments and other colorants; lubricants, and other processing aids. Those of ordinary skill in the polymer arts will be able to determine the most effective level of each additive, without undue effort.

The compositions described herein may be prepared by conventional techniques. As an example, the ingredients can be combined by dry-mixing, or by mixing in the melted state in an extruder, or in other types of mixers. (When an impact modifier is employed, the proportionate amounts of polyester and polycarbonate are usually pre-selected to match the refractive index of the modifier). The ingredients are typically in powder or granular form, and the blend can be extruded and comminuted into pellets or other suitable shapes. Substantially transparent or translucent compositions of this invention which contain an impact modifier often have Tg of at least about 100° C., and preferably, at least about 125° C.

Another embodiment of the present invention is directed to a process for making thermoplastic articles, using the resinous compositions described herein. In general, the process involves forming a resin blend of a cycloaliphatic polyester, a polycarbonate or copolycarbonate resin, and (optinally) an impact modifier. The polycarbonate resin is based on at least one of the structural units (i) and (ii) above. The cycloaliphatic polyester can be a variety of types described previously. Examples of the impact modifiers have also been described previously. Transparent or translucent impact modifiers are often preferred for many product applications. The impact modifier has a predetermined index of refraction.

As mentioned above for the case of transparent or translucent compositions, the ratio of cycloaliphatic polyester to polycarbonate components is usually selected to match the predetermined index of refraction of the impact modifier. Moreover, in the case of polycarbonate copolymers, the ratio of components in the copolymer has been pre-selected to optimize other properties, such as glass transition temperature. Impact modifier-containing resin blends of this invention are generally characterized by very desirable flow properties.

The resin blend can then be molded into an article by well-known molding techniques, e.g., injection molding. The article can be provided with a high degree of transparency by using this process. However, it is not always necessary that non-opaque articles be transparent. Often, translucency is sufficient for many products, e.g., many types of lighting fixtures. Those skilled in the plastics arts can adjust the compositional parameters discussed herein, so as to provide opaqueness, translucency, or transparency, depending on a given application.

Another embodiment of the present invention is directed to articles made by the process disclosed herein. The articles can be characterized by the desirable physical properties alluded to earlier. Examples of these properties include relatively high Tg values; relatively high notched Izod values (at room temperature and at very low temperatures of about −20° C. to −60° C.); and good chemical resistance to many substances.

A further illustration demonstrating the advantages of the present invention is based on the exemplary formulation described previously. The formulation included bisphenol A-based polycarbonate (“PC”); PCCD polyester, and a rubber-based impact modifier having a RI of 1.54. In that example, a 20/80 blend (by weight) of BPA polycarbonate/polyester would be required to match the RI of the impact modifier. Unfortunately, the resulting composition (with such a high proportion of polyester) would have a Tg of only about 85° C., which is unacceptable for many end uses.

However, if a polycarbonate homopolymer corresponding to formula IV (the “BHPM”-based material) were used in place of the BPA polycarbonate, a much different scenario would result. The BHPM-PC material has a much lower RI (1.55) than that of the BPA polycarbonate (1.58), and a much higher Tg (235° C.-245° C.). A 50/50 blend of BHPM-PC/PCCD could be used to match the RI of the same impact modifier, producing a transparent blend. Most notably, the blend would have a relatively high Tg of about 150° C., which is very desirable for many end uses. As also described herein, the ratio of BHPM to BPA in a BHPM copolymer can be selectively adjusted to vary the Tg of the PC/polyester blend over a wide range, between about 85° C. and about 150° C., while maintaining the same “target” RI.

### EXAMPLES

The examples which follow are merely illustrative, and should not be construed to be any sort of limitation on the scope of the claimed invention. The polycarbonate molecular weights (weight average) were measured against a polycarbonate standard.

The following ingredients were used:

1) L-209 was a high-temperature (“high heat”-“HH”) polycarbonate homopolymer corresponding to formula IV above. It was prepared as follows: 1,3-BHPM (5000 g, 15.4 mol) was charged to a 100L agitated reactor, along with methylene chloride (23L), water (16L), triethylamine (32 ml), and p-cumylphenol (139 g). Phosgene (2180 g, 22.0 mol) was added at 130 g/min rate, while the pH was held at 10.0-10.50, by the controlled addition of a 50% caustic solution. The resulting polymer solution was separated from the brine layer, washed with dilute HCl solution, and then washed with water until the level of titratable chloride was less than 3 ppm. The polymer was then precipitated with steam, and dried. The resulting resin had a molecular weight of about 24,585 (weight average), and about 9,622 (number average), as measured by GPC against PC standards.

2) The 1,3-BHPM copolymer (sometimes referred to herein as “L-198”) was a copolymer prepared from the BHPM material described above, along with bisphenol A. The copolymer had a molecular weight of about 29,000. The molar ratio of BHPM to bisphenol A in the copolymer was about 48:52.

3) The “BPI” material was a copolymer of bisphenol A and the dihydroxydiphenyl cycloalkane-based material on which formula VIII was based (i.e., formula II of U.S. Pat. No. 5,126,428). The material is available from Bayer as APEC® 9353. The molar ratio of bisphenol A to dihydroxydiphenyl cycloalkane was about 2:1. The material had a molecular weight of about 29,000 (polycarbonate standard).

4) The aliphatic polyester was poly(1,4-cyclohexane-dimethanol-1,4-dicarboxylate) (PCCD), available from Eastman Chemical Company. It had a melt viscosity of about 4,000 poise (at 265° C.).

### Example 1

A series of blends of the L-209 polycarbonate polymer and PCCD were prepared according to the following procedure (the quantities are changed to reflect the blend component ratios indicated in Table 1.): 1.00 g of the L-209 powder and 1.00 g of PCCD (in pellet form) were dissolved in about 30 mL of methylene chloride, at room temperature, in a 2 oz. glass vial. The solution was transferred into an aluminum pan which had a size of about 4.5 in.×3.5 in. (11.4 cm×8.9 cm). The pan was put into a convection oven pre-heated to and maintained at 60° C., for about 4 hours, until the solvent evaporated.

The resulting films were partly hazy and partly clear, due to the presence of PCCD crystallites. (Films with higher levels of PCCD exhibited more haziness). Each film was placed between two highly-polished metal plates. This structure was heated at about 300° C. for 15-30 seconds, with low pressure (about 30 psi) being applied. After this heat treatment, which melted the crystallites, all of the films were clear. The metal plates and the film were removed from the heating device. The film was cooled down to room temperature over the course of about 2 minutes.

A small section of each film (having a weight of about 10 mg) was weighed out for DSC (differential scanning calorimetry) measurement. The specimen was heated to 250° C. at 20° C./minute, and then cooled down to 40° C. at 80° C./minute. The specimen was then again heated to 250° C. at 20° C./minute, and the Tg was recorded.

The following table includes Tg values for the indicated samples:

TABLE 1

| Sample # | Wt. % L-209* | Wt. % PCCD** | Tg*** |
|---|---|---|---|
| 1^{a} | 100 | 0 | 234.8 |
| 2 | 75 | 25 | 177.5 |
| 3 | 50 | 50 | 151.1 |
| 4 | 25 | 75 | 102.1 |
| 5^{a} | 0 | 100 | 67.4 |

*Polycarbonate homopolymer corresponding to formula II above, (i.e., the “BHPM” material).
**Aliphatic polyester: poly(1,4-cyclohexane-dimethanol-1,4-dicarboxylate).
***Tg as measured by DSC.
^{a}Samples outside the scope of the present invention, i.e., 100% polycarbonate and 100% PCCD, respectively.

All of the samples exhibited polymer miscibility along the entire range of blend composition. Moreover, samples 2-4, based on the present invention, were characterized by a range of Tg values. (All of the blends exhibited a single Tg which was higher than the Tg of the PCCD itself). Sample 2, for example, would be very suitable for some high-heat applications. Sample 4 would be suitable for end uses in which a high Tg is not required. Furthermore, a composition like that of sample 4, with a high proportion of PCCD, would in some cases be especially suitable for matching the RI of an impact modifier, e.g., a rubber with a RI much less than that of standard bisphenol A polycarbonate. For example, such a blend would be very useful for products which require both low-temperature ductility and high transparency or translucency. The same general conclusion can be stated for samples 2 and 3. In each instance, the most appropriate polycarbonate/polyester ratio will depend on how much aliphatic polyester is required to match the RI of a particular impact modifier (when included), as well as other factors, such as required ductility and Tg levels.

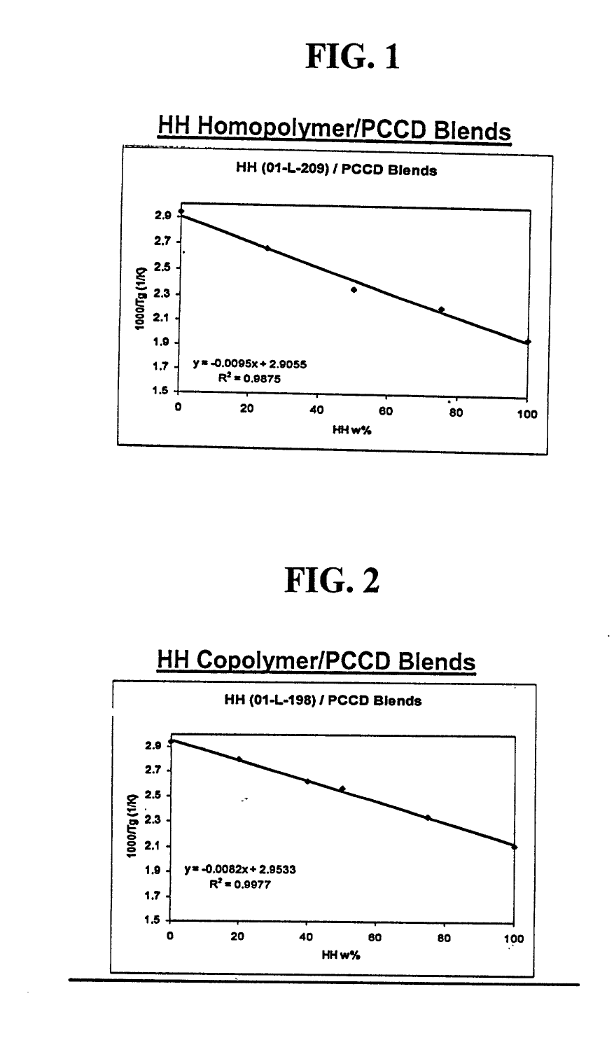

FIG. 1 is a graph based on the data of Table 1. The y-axis represents the reciprocal of the Tg values, while the x-axis represents the weight percentage of L-209 high-temperature polycarbonate homopolymer in the blend (the remainder being PCCD). The graph demonstrates that the indicated blends are miscible over the entire range of composition-constituents. Moreover, the Tg can be readily predicted, based on the presence of these two constituents. This predictability would, in turn, allow convenient and accurate adjustment of the polycarbonate/polyester ratio when other ingredients are added, such as a rubbery impact modifier.

### Example 2

A series of blends of the BHPM copolymer (Ingredient 2) and PCCD were prepared according to the general procedure outlined in Example 1. In each instance, a small section of the film (having a weight of about 10 mg) was weighed out for DSC, and then subjected to Tg measurement. The following table includes Tg values for the indicated samples:

TABLE 2

| Sample # | Wt. % L-198* | Wt. % PCCD** | Tg*** |
|---|---|---|---|
| 6^{a} | 100 | 0 | 198.8 |
| 7 | 75 | 25 | 154.1 |
| 8 | 50 | 50 | 116.8 |
| 9 | 40 | 60 | 108.1 |
| 10 | 20 | 80 | 84.3 |
| 11^{a} | 0 | 100 | 67.4 |

*Polycarbonate copolymer (Ingredient #2 up above)
**Aliphatic polyester: poly(1,4-cyclohexane-dimethanol-1,4-dicarboxylate).
***Tg as measured by DSC.
^{a}Samples outside the scope of the present invention, i.e., 100% polycarbonate and 100% PCCD, respectively.

As in Example 1, all of the samples here exhibited polymer miscibility along a wide range of blend composition. Moreover, all of the films were optically clear after being subjected to a heat treatment.

Samples 7-10, based on the present invention, were characterized by a range of Tg values, as in the case of the polycarbonate homopolymer of Example 1. Again, some of the samples are very desirable for high temperature applications, while others would be suitable for end uses in which a high Tg is not required.

FIG. 2 is a graph based on the data of Table 2. As in FIG. 1, the y-axis represents the reciprocal of the Tg values, while the x-axis represents the weight percentage of the L-198 polycarbonate copolymer in the blend. The graph demonstrates that the indicated blends are miscible over the entire range of composition-constituents. Furthermore, predictability of the Tg has been demonstrated. This provides a convenient way to selectively modify the composition (with or without other components such as a rubber), depending on the specifications for a given application.

Thus, it should be emphasized that the compositions of this example are especially useful because at least two parameters are adjustable. In other words, the polycarbonate copolymer-polyester ratio can be adjusted, and the ratio of the components in the polycarbonate copolymer itself (here, BPA and BHPM) can also be adjusted. By altering the latter ratio first, one can readily adjust the Tg and RI of the polycarbonate phase, independently of the polyester phase. The most appropriate ratio (e.g., in terms of Tg requirements) for the copolymer can then be employed for blending with selected amounts of the polyester. This flexibility allows a formulator to very easily match the RI of an impact modifier that might be present.

### Example 3

A series of blends of the “BPI” material (Ingredient #3 above—Bayer APEC@9353) and PCCD were prepared according to the procedure outlined in Example 1. After casting from the methylene chloride solution, the resulting films were partly hazy and partly clear, as in Example 1. After a heat treatment, all of the films were clear. The following blends were prepared in this manner:

TABLE 3

| Sample # | Wt. % APEC* | Wt. % PCCD** | Tg*** |
|---|---|---|---|
| 12^{a} | 100 | 0 | 185.4 |
| 13 | 75 | 25 | 148.0 |
| 14 | 50 | 50 | 119.7 |
| 15 | 25 | 75 | 89.1 |
| 16^{a} | 0 | 100 | 67.4 |

*APEC ® 9353 polycarbonate copolymer
**Aliphatic polyester: poly(1,4-cyclohexane-dimethanol-1,4-dicarboxylate).
***Tg as measured by DSC.
^{a}Samples outside the scope of the present invention, i.e., 100% polycarbonate and 100% PCCD, respectively.

As in the previous examples, all of the samples here exhibited polymer miscibility over a wide range of blend composition. Furthermore, samples 13-15, based on the present invention, were characterized by a range of Tg values. Again, some of the samples are very desirable for high temperature applications, whiles others would be suitable for end uses in which a high Tg is not required. All of the blends exhibited single Tg values which were higher than that of the aliphatic polyester itself.

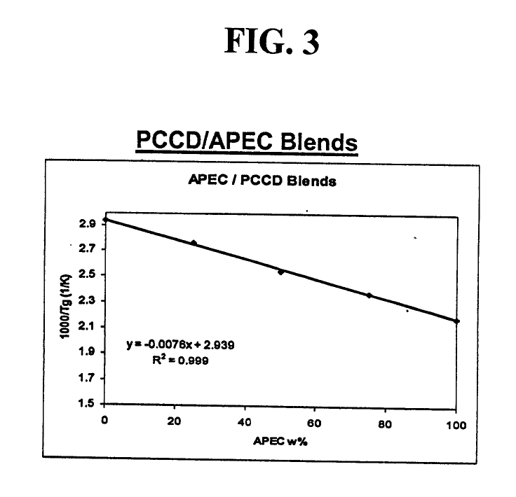

FIG. 3 is a graph based on the data of Table 3. As in FIGS. 1 and 2, the y-axis represents the reciprocal of the Tg values, while the x-axis represents the weight percentage of the APEC® polycarbonate copolymer in the blend. The graph demonstrates that the indicated blends are miscible over the entire range of composition-constituents. Furthermore, predictability of the Tg has been demonstrated. As in Example 2, the ratio of components in the polycarbonate copolymer can be varied in conjunction with the PC/polyester ratio, to suit the needs of a particular application.

### Example 4

Several additional blends were prepared, each based on the present invention. Sample 17 was based on a blend of PCCD and the BPI/polycarbonate copolymer described previously. Sample 18 was based on a blend of PCCD and the 1,3-BHPM copolymer, also described above. The compositions were as follows:

TABLE 4

| | Sample 17 | Sample 18 |
|---|---|---|
| Composition | (Wt. %) | (Wt. %) |
| PCCD | 49.9 | 49.9 |
| BPI/BPA Copolymer* | 49.9 | — |
| BHPM/BPA Copolymer** | — | 49.9 |
| Stabilizer 1*** | 0.15 | 0.15 |
| Stabilizer 2**** | 0.05 | 0.05 |

*APEC ®9353
**L-198
***Clariant Sandostab ™ PEPQ-phosphorous-based heat stabilizer
****Zinc-phosphate-based quencher

Each sample was blended and extruded at 545/550° F. (285/304° C.). A twin-screw extruder was used, operating at 300 rpm, under 20 inches vacuum. The extruded pellets were dried for 4 hours at 180° F. (82° C.). The dried pellets were then molded (550° F. (288° C.)) into various test specimens, in a 150° F. (66° C.) mold.

The following optical properties were obtained, based on specimens having a thickness of 125 mils (3.2 mm):

TABLE 5

| | Sample 17 | Sample 18 |
|---|---|---|
| % Transmission* | 90.2 | 89.6 |
| % Haze** | 3.6 | 4.4 |
| YI*** | 3.2 | 3.4 |

*ASTM D1003-00
**ASTM D1003-00
***Yellowness Index; ASTM-E313-73, D1925

The data demonstrate very good optical characteristics for extruded samples of the claimed compositions.

While a number of embodiments are described herein, it will be appreciated from the specification that other variations of the invention may be contemplated by those skilled in the art. Those variations are within the scope of the presently-claimed invention. All of the patents, patent specifications, and articles mentioned herein are incorporated by reference.

What is claimed:

1. A thermoplastic composition, comprising:
a) from about 1 part by weight to about 99 parts by weight of a cycloaliphatic polyester resin; and
b) from about 99 parts by weight to about 1 part by weight of a polycarbonate or copolycarbonate comprising
(i) at least one of the structural units 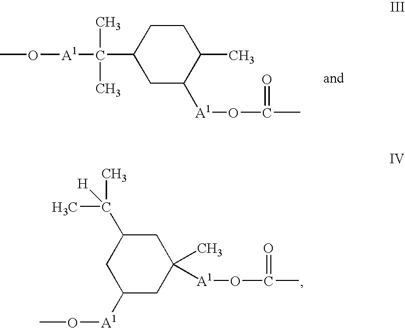
wherein each A¹ is independently a divalent substituted or unsubstituted aromatic group; or 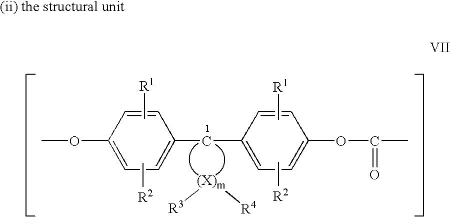
wherein each R¹ and R² is independently hydrogen, halogen, C₁-C₈ alkyl, C₅-C₆ cycloalkyl, C₅-C₁₀ aryl, and C₇-C₁₂ aralkyl;
m is an integer of from about 4 to about 7;
R³ and R⁴ are individually selectable for each X, and independently represent hydrogen or C₁-C₆ alky; and
X represents carbon, with the proviso that, for at least one atom X, both R³ and R⁴ are alkyl.

2. The composition of claim 1, wherein the ratio of cycloaliphatic polyester resin to polycarbonate or copolycarbonate resin is in the range of about 80:20 to about 5:95, by weight.

3. The composition of claim 1, wherein the cycloaliphatic polyester resin comprises the reaction product of a C₂-C₁₂ diol or chemical equivalent, and a C₆-C₁₂ aliphatic diacid or chemical equivalent.

4. The composition of claim 3, wherein the cycloaliphatic polyester resin contains at least about 50% by weight of (i) a cycloaliphatic dicarboxylic acid, or chemical equivalent; (ii) a cycloaliphatic diol or chemical equivalent; or (iii) a combination of (i) and (ii).

5. The composition of claim 1, wherein the cycloaliphatic polyester resin comprises recurring units of the formula 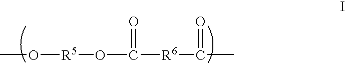
wherein R⁵ represents an alkyl, aryl, or cycloalkyl radical containing 2 to about 20 carbon atoms, which is the residue of a straight chain, branched, or cycloaliphatic alkane diol having about 2 to about 12 carbon atoms or chemical equivalents thereof; and R⁶ is an alkyl or a cycloaliphatic radical which is the decarboxylated residue derived from a diacid or chemical equivalent thereof, with the proviso that at least one of R⁵ and R⁶ is a cycloalkyl group.

6. The composition of claim 5, wherein the cycloaliphatic polyester resin is poly(1,4-cyclohexane-dimethanol-1,4-dicarboxylate) (PCCD).

7. The composition of claim 1, wherein the polycarbonate is a homopolycarbonate.

8. The composition of claim 7, wherein the homopolycarbonate is derived from a bisphenol selected from the group consisting of 4-[1-[3-(4-hydroxyphenyl)-4-methylcyclohexyl]-1-methylethyl]-phenol (BPT-1) and 4,4′-[1-methyl-4-(1-methylethyl)-1,3-cyclohexandiyl]bisphenol (BPT-2).

9. The composition of claim 1, wherein the polycarbonate is a copolycarbonate.

10. The composition of claim 9, wherein the copolycarbonate also comprises at least one of the structural units of the formula 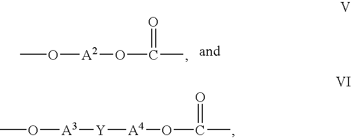
wherein A² is a divalent substituted or unsubstituted aliphatic, alicyclic or aromatic radical; and A³ and A⁴ are each independently a monocyclic divalent aromatic radical, and Y is a bridging radical.

11. The composition of claim 9, wherein the copolycarbonate is derived from a combination of bisphenol A and 4,4′-[1-methyl-4-(1-methylethyl)-1,3-cyclohexandiyl]bisphenol (BPT-2).

12. The composition of claim 11, wherein the weight ratio of bisphenol A to BPT-2 ranges from about 1:99 to about 99:1.

13. The composition of claim 9, wherein the copolycarbonate is derived from a combination of bisphenol A and a dihydroxydiphenyl cycloalkane corresponding to the formula 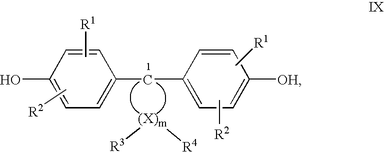
wherein R¹, R², R³, R⁴, X, and m are as defined previously.

14. The composition of claim 13, wherein the weight ratio of bisphenol A to dihydroxy compound IX ranges from about 1:99 to about 99:1.

15. The composition of claim 1, wherein, for the polycarbonate or copolycarbonate of structural unit (ii) (formula VII), R³ and R⁴ for at least one atom “X” is each, independently, alkyl.

16. The composition of claim 15, wherein R³ and R⁴ for at least one atom “X” are each methyl.

17. The composition of claim 15, wherein one X-atom in a beta position to C-1 is dialkyl-substituted, and one X-atom in a beta′ position to C-1 is monoalkyl-substituted.

18. The composition of claim 15, wherein the diphenyl-substituted C atom (C-1) and the X atoms form cycloaliphatic radicals containing five or six carbon atoms.

19. The composition of claim 18, wherein the polycarbonate or copolycarbonate of structural unit (ii) (formula VII) comprises units corresponding to the formula 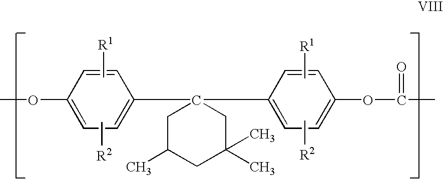
wherein R¹ and R² are as defined above.

20. The composition of claim 19, wherein R¹ and R² are hydrogen.

21. The composition of claim 19, wherein the polycarbonate is a homopolycarbonate.

22. The composition of claim 19, wherein the polycarbonate is a copolycarbonate.

23. The composition of claim 22, wherein the copolycarbonate also comprises at least one of the structural units of the formula 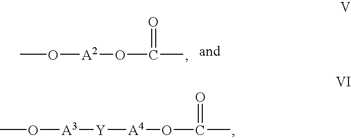
,wherein A² is a divalent substituted or unsubstituted aliphatic, alicyclic or aromatic radical; A³ and A⁴ are each independently a monocyclic divalent aromatic radical; and Y is a bridging radical.

24. The composition of claim 1, wherein the polyester resin is prepared by the condensation- or ester interchange-polymerization of a diol or diol-equivalent component with a diacid or diacid-equivalent component.

25. The composition of claim 1, wherein the polycarbonate or copolycarbonate resin is prepared by a technique selected from the group consisting of (A) melt polymerization, (B) interfacial polymerization, and (C) interfacial conversion to bischloroformates, followed by polymerization.

26. A substantially-transparent molding composition according to claim 1.

27. The thermoplastic composition of claim 1, further comprising at least one impact modifier.

28. The composition of claim 27, wherein the impact modifier is an amorphous resin.

29. The composition of claim 27, wherein the impact modifier has a refractive index between about 1.51 and about 1.58.

30. The composition of claim 29, wherein the refractive index of components (a) and (b), as combined, is substantially equal to the refractive index of the impact modifier.

31. The composition of claim 27, wherein the impact modifier is selected from the group consisting of graft or core-shell acrylic rubbers, diene rubber polymers, and silicone rubber polymers.

32. The composition of claim 27, wherein the impact modifier comprises an acrylic core-shell polymer.

33. The composition of claim 27, wherein the impact modifier is present in the composition at a level of about 1% by weight to about 30% by weight, based on the weight of the entire composition.

34. A transparent or translucent composition, comprising
(I) poly(1,4-cyclohexane-dimethanol-1,4-dicarboxylate);
(II) a copolycarbonate derived from a combination of
(a) at least one of
(i) 4-[1-[3-(4-hydroxyphenyl)-4-methylcyclohexyl]-1-methylethyl]-phenol (BPT-1);
(ii) 4,4′-[1-methyl-4-(1-methylethyl)-1,3-cyclohexandiyl] bisphenol (BPT-2); and
(iii) a dihydroxydiphenyl cycloalkane corresponding to the formula 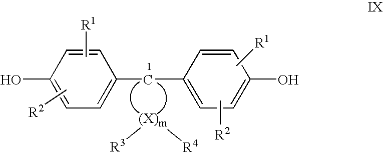
wherein each R¹ and R² is independently hydrogen, halogen, C₁-C₈ alkyl, C₅-C₆ cycloalkyl, C₅-C₁₀ aryl, and C₇-C₁₂ aralkyl; m is an integer of from about 4 to about 7; R³ and R⁴ are individually selectable for each X, and independently represent hydrogen or C₁-C₆ alkyl; and X represents carbon, with the proviso that, for at least one atom X, both R³ and R⁴ are alkyl; and
(b) at least one of the structural units of the formulae 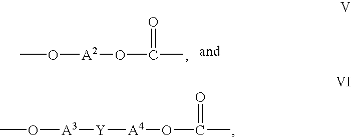
wherein A² is a divalent substituted or unsubstituted aliphatic, alicyclic or aromatic radical; and A³ and A⁴ are each independently a monocyclic divalent aromatic radical, and Y is a bridging radical; and
(III) a rubbery impact modifier;
wherein the ratio of component I to component II ranges from about 80:20 to about 5:95, by weight; and wherein component III is present at a level of about 1% by weight to about 30% by weight, based on the weight of the entire composition.

35. A process for molding thermoplastic articles, comprising the following steps:
(I) forming a resin blend of a cycloaliphatic polyester, a polycarbonate or copolycarbonate resin, and an impact modifier having a predetermined index of refraction, in selected proportions, wherein the relative proportions of the polyester and the polycarbonate or copolycarbonate resin are selected to match the index of refraction of the impact modifier; and then
(II) molding an article from the resin blend;
wherein the polycarbonate or copolycarbonate resin comprises
(i) at least one of the structural units 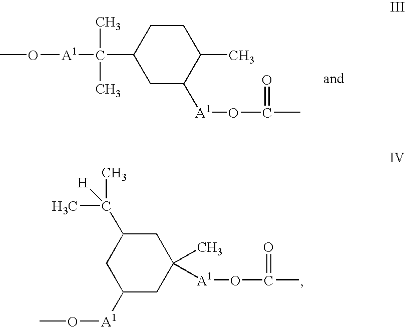
wherein each A¹ is independently a divalent substituted or unsubstituted aromatic group; or 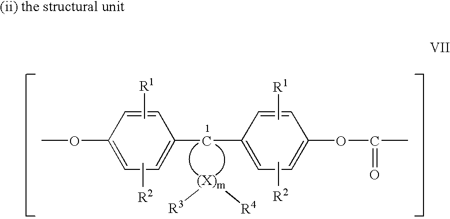
wherein each R¹ and R² is independently hydrogen, halogen, C₁-C₈ alkyl, C₅-C₆ cycloalkyl, C₅-C₁₀ aryl, and C₇-C₁₂ aralkyl; m is an integer of from about 4 to about 7; R³ and R⁴ are individually selectable for each X, and independently represent hydrogen or C₁-C₆ alkyl; and X represents carbon, with the proviso that, for at least one atom X, both R³ and R⁴ are alkyl.

36. The process of claim 35, wherein the cycloaliphatic polyester resin is poly(1,4-cyclohexane-dimethanol-1,4-dicarboxylate) (PCCD).

37. The process of claim 35, wherein the resin blend is translucent or substantially transparent, and has a glass transition temperature (Tg) of at least about 100° C.

38. The process of claim 35, wherein step (II) is carried out by injection molding.

39. An article prepared by the process of claim 35.

40. A process for forming a molding composition for preparing substantially transparent articles, comprising the steps of
selecting a substantially transparent impact modifier having a first index of refraction;
selecting a cycloaliphatic polyester and a polycarbonate or copolycarbonate resin, wherein the combination of the polyester and the polycarbonate or copolycarbonate provides a second index of refraction; and then
forming a resin blend of the cycloaliphatic polyester, the polycarbonate or copolycarbonate resin, and the impact modifier, by mixing the components in proportions which are selected to match the first index of refraction with the second index of refraction; and
molding a substantially transparent article from the resin blend;
wherein the polycarbonate resin is a homopolymer or copolymer comprising
(i) at least one of the structural units 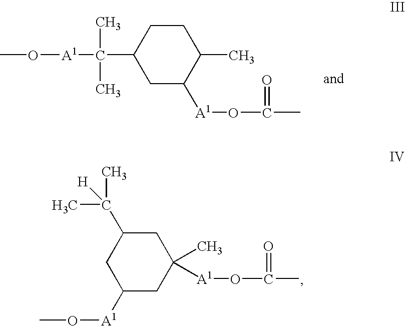
wherein each A¹ is independently a divalent substituted or unsubstituted aromatic group; or 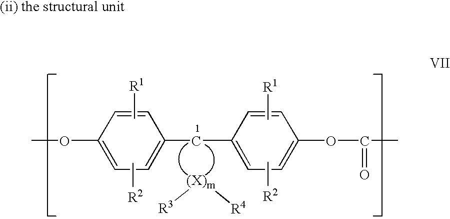
wherein each R¹ and R² is independently hydrogen, halogen, C₁-C₈ alkyl, C₅-C₆ cycloalkyl, C₅-C₁₀ aryl, and C₇-C₁₂ aralkyl; m is an integer of from about 4 to about 7; R³ and R⁴ are individually selectable for each X, and independently represent hydrogen or C₁-C₆ alkyl; and X represents carbon, with the proviso that, for at least one atom X, both R³ and R⁴ are alkyl.

41. A substantially transparent, extruded sheet, comprising the thermoplastic composition of claim 1.
